(19) United States
(12) Patent Application Publication
(10) Pub. No.: US 2010/0223775 A1
(43) Pub. Date: Sep. 9, 2010

(54) METHOD FOR DISMOUNTING ELECTRONIC DEVICE

(75) Inventor: Osamu HIGASHI, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/694,204

(22) Filed: Jan. 26, 2010

(30) Foreign Application Priority Data
Mar. 4, 2009 (JP) 2009-50623

(51) Int. Cl. B23P 19/00

(52) U.S. Cl. 29/426.2

(57) ABSTRACT

A method for dismounting an electronic device that is mounted on a printed board by solder including heating the electronic device by dipping the electronic device in inert liquid heated in a heating bath and melting the solder in the through-hole using heat transferred from the electronic device. The electronic device has a terminal pin disposed in a through-hole of the printed board extending from a front surface to a back surface of the printed board. The terminal pin is joined to the printed board by the solder.

### CROSS-REFERENCE TO RELATED APPLICATION

This application is based upon and claims the benefit of priority of the prior Japanese Patent Application No. 2009-50623, filed on Mar. 4, 2009, the entire contents of which are incorporated herein by reference.

### FIELD

Aspects of the embodiments discussed herein are related to a method for dismounting an electronic device, such as an insertion mount device (IMD).

### BACKGROUND

A plurality of electronic devices is mounted on a printed board. In order to mount electronic devices on a printed board, terminal pins that protrude from the bodies of the electronic devices are used. Each of the terminal pins is disposed in a through-hole formed in the printed board. The top portion of the terminal pin protrudes from, for example, the back surface of the printed board. The electronic device is mounted using solder with which the through-holes are filled. If a malfunction of an electronic device is detected, the electronic device is dismounted from the printed board.

In order to dismount an electronic device, the back surface of the printed board is dipped in a melted solder bath. Since the solder is melted, the terminal pins, the through-hole portions, and the unmelted solder in the through-holes are heated. As a result, the solder in the through-hole is heated. When the solder is melted, the body of the electronic device is raised from the front surface of the printed board. The terminal pins are removed from the through-holes. Thus, the electronic device is dismounted from the printed board (refer to, for example, Japanese Laid-open Patent Publication Nos. 2000-315859, 2001-94248, and 2004-22607).

In the above-mentioned method for dismounting an electronic device, melted solder is in contact with a land formed on the back surface of a printed board around a through-hole. For example, if the printed board is thick, the temperature of solder in the through-hole does not easily rise. Accordingly, the solder needs to be heated for a long time. As a result, since the land is in contact with melted solder, copper of the land dissolves into the melted solder. Thus, a reaction layer may be formed on the surface of the copper. That is, the surface of the copper is damaged.

### SUMMARY

According to aspects in accordance with an embodiment, a method for dismounting an electronic device which is mounted on a printed board by solder includes heating the electronic device by dipping the electronic device in inert liquid heated in a heating bath and melting the solder in the through-hole using heat transferred from the electronic device. The electronic device has a terminal pin disposed in a through-hole of the printed board extending from a front surface to a back surface of the printed board. The terminal pin is joined to the printed board by the solder.

It is to be understood that both the foregoing general description and the following detailed description are exemplary, and do not restrict the invention as claimed. Additional advantages and novel features of aspects will be set forth in part in the description that follows, and in part will become more apparent to those skilled in the art upon examination of the following or upon learning by practice thereof.

### BRIEF DESCRIPTION OF THE DRAWINGS

FIG. 1 is a schematic perspective view of the appearance of a server computer apparatus, which is an example of an electronic apparatus;

FIG. 2 is a schematic partial cross-sectional view of the structure of a printed board unit;

FIG. 3 is a schematic illustration of the structure of a heating bath used for dismounting an electronic device in accordance with aspects of the present invention;

FIG. 4 is a schematic illustration of an electronic device being dipped in inert liquid in a heating bath in accordance with aspects of the present invention;

FIG. 5 is a schematic illustration of an electronic device dropping in inert liquid in a heating bath in accordance with aspects of the present invention;

FIG. 6 is a schematic illustration of a supply nozzle disposed on the back surface of a printed board in accordance with aspects of the present invention;

FIG. 7 is a schematic illustration of the inert liquid being supplied from a supply nozzle to a through-hole in accordance with aspects of the present invention;

FIG. 8 is a schematic illustration of the inert liquid being supplied to from a supply nozzle to a through-hole in accordance with aspects of the present invention;

FIG. 9 is a schematic illustration of a weight being attached to the body of an electronic device in accordance with aspects of the present invention;

FIG. 10 is a schematic illustration of a coil spring being attached to the body of an electronic device in accordance with aspects of the present invention;

FIG. 11 is a schematic illustration of a pushing mechanism pushing a terminal pin on the back surface of a printed board in accordance with aspects of the present invention; and

FIG. 12 is a schematic illustration of the inert liquid being supplied from a supply nozzle to a through-hole in accordance with aspects of the present invention.

### DESCRIPTION OF EMBODIMENTS

Aspects in accordance with the present invention are described below with reference to the accompanying drawings.

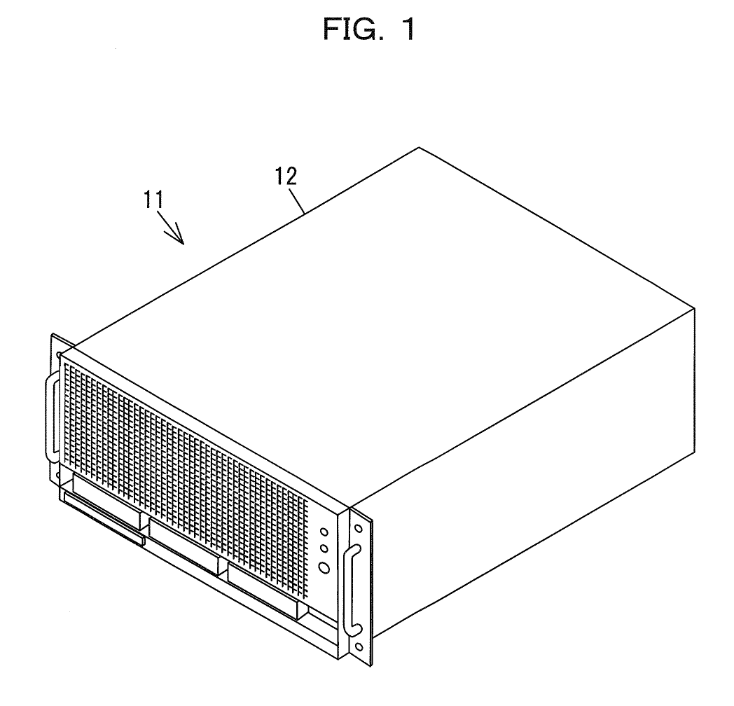

FIG. 1 is a schematic external view of a server computer apparatus 11, which is an example of an electronic apparatus. The server computer apparatus 11 includes a chassis 12. The space in the chassis 12 is partitioned into several container spaces. A printed board unit 13 (not shown) including a motherboard is disposed in one of the container spaces. A variety of semiconductor devices that perform computation and a main memory are mounted on the motherboard. The server computer apparatus 11 is mounted in a rack.

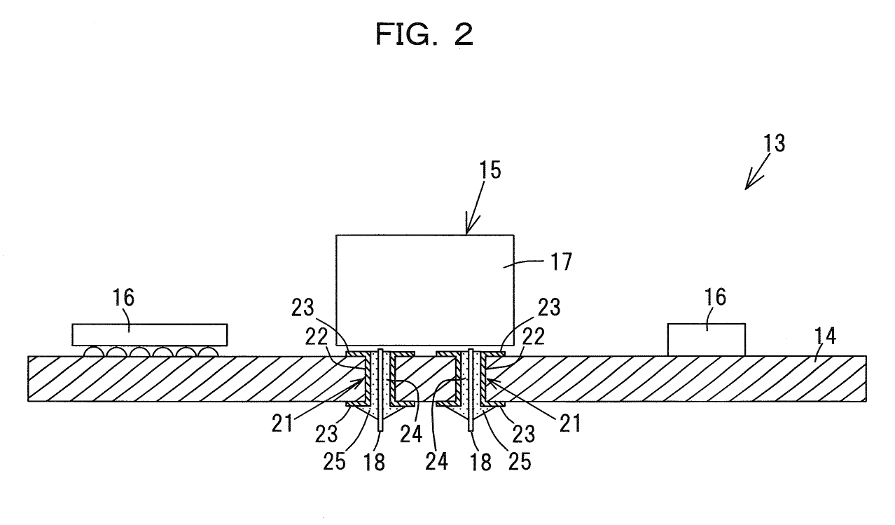

FIG. 2 is a schematic illustration of the structure of the printed board unit 13. The printed board unit 13 includes, for example, a printed board 14 formed from resin. An electronic device 15 and other electronic devices 16 are mounted on a front surface of the printed board 14. The electronic devices 16 are disposed in the vicinity of the electronic device 15. The electronic device 15 is formed as an insertion mount device (IMD). The electronic device 15 includes a main electronic device body 17. For example, a pair of terminal pins 18 protrudes from the back surface of the main electronic device body 17. Each of the terminal pins 18 is disposed in a through-hole 21 formed in the printed board 14. In this example, the top portion of the terminal pin 18 protrudes from the back surface of the printed board 14.

The through-hole 21 is formed by drilling the printed board 14. The inner surface of the through-hole 21 serves as a conductive wall 22. The terminal pin 18 is disposed in a columnar space formed by the conductive wall 22. The conductive wall 22 is connected to, for example, a ring-shaped land 23 formed on the front surface or the back surface of the printed board 14 so as to surround the opening of the through-hole 21. The land 23 is connected to a wiring pattern (not shown) formed on the front surface or back surface of the printed board 14. For example, the conductive wall 22 and the land 23 are formed of a conductive material, such as copper.

The inner space formed by the conductive wall 22 of the through-hole 21 is filled with solder 24. At that time, the entire inner space of the through-hole 21 is filled with the solder 24. Thus, the terminal pin 18 is electrically connected to the conductive wall 22 by the solder 24. In this way, the electronic device 15 is mounted on the printed board 14. For example, lead-free solder is used as the solder 24. Lead-free solder is formed from, for example, an alloy of tin, silver, and copper. The solder 24 forms a fillet 25 on the back surface of the printed board 14 around the terminal pin 18.

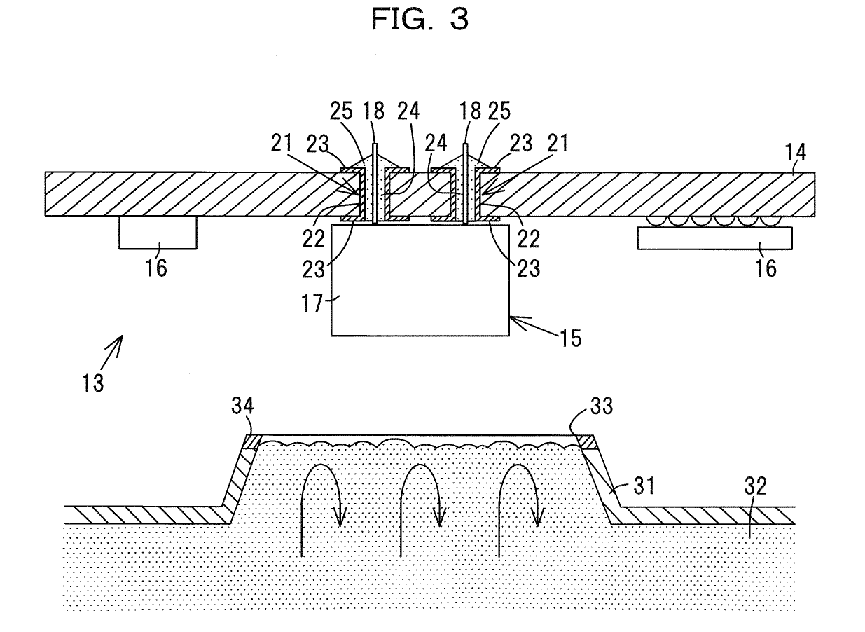

A method for dismounting the electronic device 15 according to a first embodiment in accordance with aspects of the present invention is described next. As shown in FIG. 3, in order to dismount the electronic device 15, a heating bath 31 is used. Heated high-temperature inert liquid 32 circulates in the heating bath 31 by convection. The inert liquid 32 is inert with respect to copper and the resin material. In addition, the inert liquid 32 is formed of a material that is chemically stable for copper and the resin material. In this example, fluorinated liquid, such as inert perfluoropolyether, is used as the inert liquid 32. For example, Fluorinert available from 3M Company or Galden® available from Ausimont Inc. is used as the fluorinated liquid. The temperature of the inert liquid 32 in the heating bath 31 is set to a temperature at which the inert liquid 32 is not thermally decomposed and that is higher than the melting point of the solder 24. The specific gravity of the inert liquid 32 is set so as to be smaller than the specific gravity of the main electronic device body 17 of the electronic device 15.

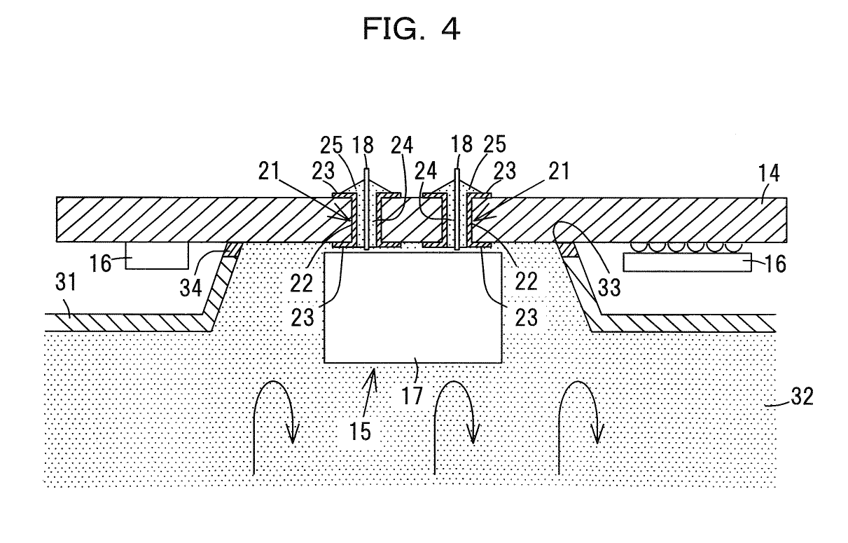

In the printed board unit 13, the front surface of the printed board 14 is made to face downward in the vertical direction. An opening 33 of the heating bath 31 is made to face the front surface of the printed board 14. At that time, as shown in FIG. 4, the main electronic device body 17 is dipped in the inert liquid 32. The electronic devices 16 disposed so as to surround the main electronic device body 17 are located outside the opening 33. The printed board 14 is in contact with a cushion 34 disposed so as to surround the opening 33. The front surface of the printed board 14 (the surface having the electronic devices 16 mounted thereon) and the main electronic device body 17 are exposed to the jet flow of the inert liquid 32. Thus, the front surface of the printed board 14 and the main electronic device body 17 are heated. As a result, the thermal energy is transferred from the main electronic device body 17 to the solder 24 via the terminal pin 18. In addition, the thermal energy is transferred from the front surface of the printed board 14 to the solder 24 via the conductive wall 22 and the land 23.

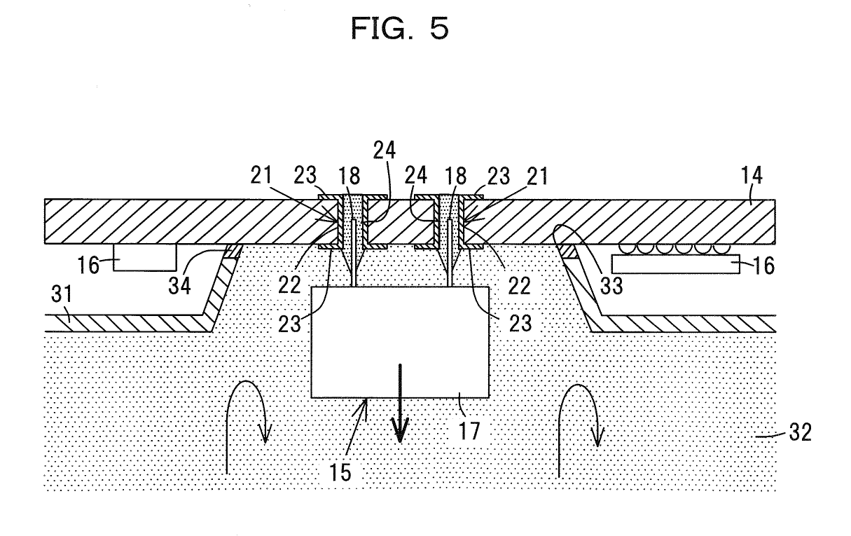

When the temperature of the solder 24 is increased to a temperature higher than the melting point of the solder 24, the solder 24 is melted. Thus, the adherence of the terminal pin 18 to the solder 24 is reduced. Since the specific gravity of the inert liquid 32 is smaller than that of the main electronic device body 17, the main electronic device body 17, as shown in FIG. 5, drops into the heating bath 31 due to the weight of the main electronic device body 17. Due to the dropping, the terminal pin 18 is pulled out of the through-hole 21. In this way, the electronic device 15 is dismounted from the front surface of the printed board 14. Thereafter, the printed board 14 is raised from the heating bath 31. The solder 24 remaining on the conductive wall 22 of the through-hole 21 is then removed. The electronic device 15 is then collected from the heating bath 31.

In such a method for dismounting an electronic device, the front surface of the printed board 14 and the main electronic device body 17 are exposed to the jet flow of the inert liquid 32. Since the inert liquid 32 is inert with respect to copper, chemical reaction between the inert liquid 32 and the conductive wall 22 and between the inert liquid 32 and the land 23 is reliably prevented and, therefore, damage of the conductive wall 22 and the land 23 is reliably prevented. Thus, damage of the printed board 14 is prevented. In addition, since the front surface of the printed board 14 is exposed to the inert liquid 32, the thermal energy is transferred from the conductive wall 22 and the land 23 to the solder 24. Accordingly, the solder 24 is efficiently heated and, therefore, the solder 24 is melted in a relatively short time. Furthermore, since the electronic device 15 drops into the heating bath 31 due to the weight of the electronic device 15, an operation to dismount the electronic device 15 can be eliminated.

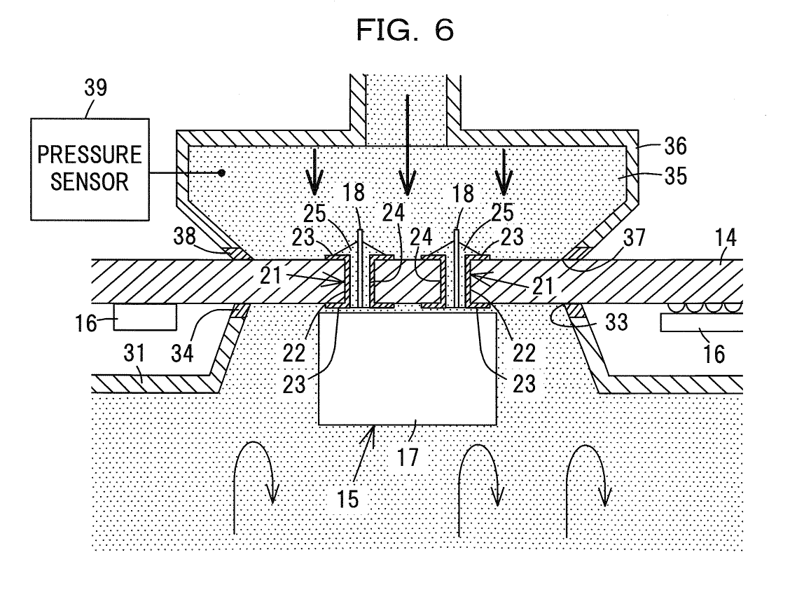

A method for dismounting the electronic device 15 according to a second embodiment of the present invention is described next. In this method, as shown in FIG. 6, the top portion of a supply nozzle 36 for supplying high-temperature inert liquid 35 is disposed on the back surface of the printed board 14. Fluorinated liquid used as the inert liquid 32 is also used in the supply nozzle 36 for supplying high-temperature inert liquid 35. An opening 37 formed in the top portion of the supply nozzle 36 is made to face the back surface of the printed board 14. A cushion 38 is disposed on the top portion of the supply nozzle 36, that is, on the periphery of the opening 37. When, on the back side of the electronic device 15, the top portion of the supply nozzle 36 is in contact with the back surface of the printed board 14 via the cushion 38, the terminal pin 18, the land 23, and a fillet 25 are located inside the supply nozzle 36.

At that time, the inert liquid 35 in the supply nozzle 36 has a pressure higher than that of the inert liquid 32 in the heating bath 31. In order to apply a pressure to the inert liquid 35, a pressure pump (not shown) is connected to the supply nozzle 36. Thus, the inert liquid 35 in the supply nozzle 36 has a desired pressure in accordance with the setting of the pressure pump. In addition, a pressure sensor 39 is disposed in the supply nozzle 36. The pressure of the inert liquid 35 in the supply nozzle 36 is controlled on the basis of the pressure measured by the pressure sensor 39.

By using the supply nozzle 36, the back surface of the printed board 14 is exposed to the inert liquid 35. In addition, the terminal pin 18, the land 23, and the fillet 25 are exposed to the inert liquid 35 in the supply nozzle 36. Thus, the terminal pin 18, the land 23, and the fillet 25 are heated on the back surface of the printed board 14 by the heat of the inert liquid 35 in addition to the heat of the above-described solder 24 in the heating bath 31. The thermal energy is transferred from the terminal pin 18, the land 23, and the conductive wall 22 to the solder 24. When the temperature of the solder 24 is increased to a temperature higher than the melting point of the solder 24, the solder 24 is melted. Thus, the adherence of the terminal pin 18 to the solder 24 is reduced.

Like the first embodiment, the front surface of the printed board 14 is made to face downward in the vertical direction. The specific gravity of the inert liquid 32 is set so as to be smaller than the specific gravity of the main electronic device body 17 of the electronic device 15. Accordingly, the main electronic device body 17 drops into the heating bath 31 due to the weight of the main electronic device body 17. In addition, the pressure in the supply nozzle 36 is set so as to be higher than the pressure in the heating bath 31. Accordingly, the inert liquid 35 in the supply nozzle 36 flows into the heating bath 31 via the through-hole 21. Thus, the inert liquid 35 applies a force to the electronic device 15 so that the electronic device 15 is moved away from the printed board 14. The inert liquid 35 facilitates dropping of the main electronic device body 17. In this way, the electronic device 15 is dismounted from the front surface of the printed board 14.

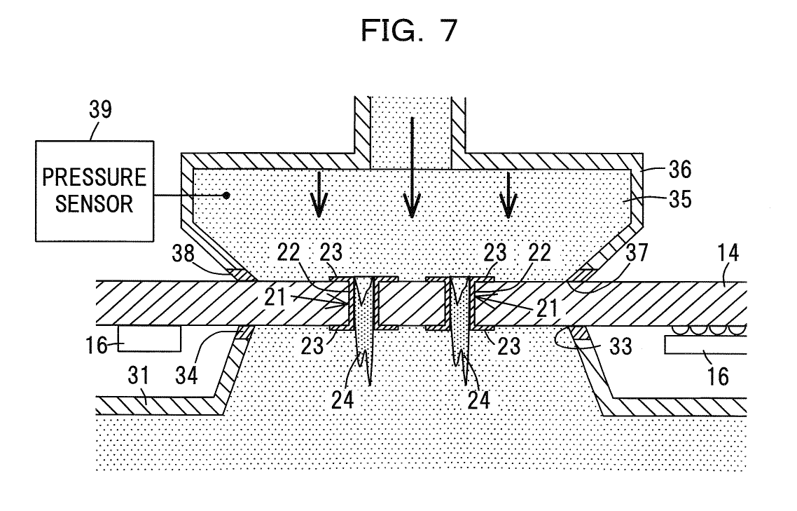

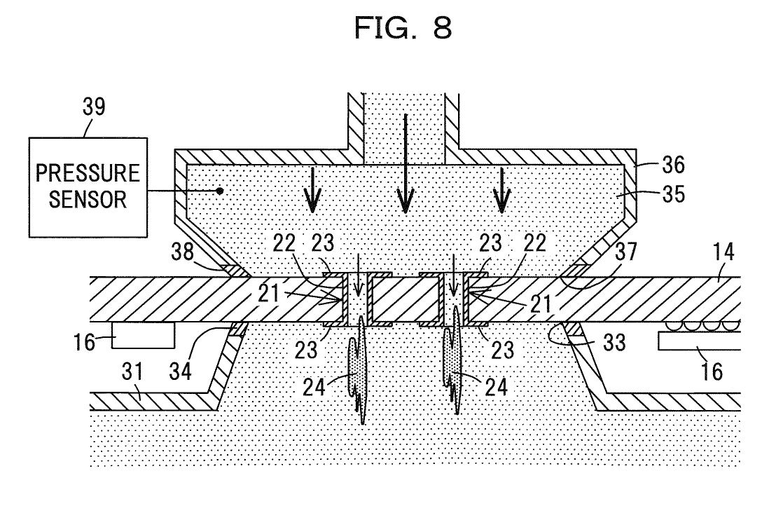

After the electronic device 15 is dismounted from the front surface of the printed board 14, the heating bath 31 and the supply nozzle 36 still remain on the front surface and the back surface of the printed board 14, respectively. Due to the difference between the pressures, the inert liquid 35 continues to flow from the supply nozzle 36 into the heating bath 31 via the through-hole 21. As shown in FIG. 7, the solder 24 remaining in the through-hole 21 is completely melted. As a result, as shown in FIG. 8, the solder 24 is pushed out from the through-hole 21 to the heating bath 31. In this way, the solder 24 can be prevented from remaining in the through-hole 21. Note that as the solder 24 is pushed out, the flow velocity of the inert liquid 35 in the through-hole 21 is increased. Accordingly, pushing-out of the solder 24 can be detected by monitoring the flow velocity.

In the above-described method for dismounting the electronic device 15, the solder 24 is heated by the front and back surfaces of the printed board 14 due to the heating bath 31 and the supply nozzle 36. Since the inert liquid 32 and 35 are used for heating the solder 24, chemical reaction between one of the inert liquid 32 and 35 and one of the conductive wall 22 and the land 23 is reliably prevented, and therefore, damage of the conductive wall 22 or the land can be reliably prevented. Thus, damage of the printed board 14 is prevented. In addition, since the solder 24 is efficiently heated by the front and back surfaces of the printed board 14, the solder 24 is melted in a short time. As a result, the temperatures of the inert liquid 32 and 35 can be set so as to be lower than the above-described temperature. Furthermore, a flow of the inert liquid 35 from the supply nozzle 36 towards the heating bath 31 is generated due to the difference in pressures. Such a flow facilitates the dropping of the electronic device 15 and pushing-out of the solder 24. Thus, the electronic device 15 can be dismounted without any other operation. Still furthermore, the solder 24 can be prevented from remaining in the photodiode 21.

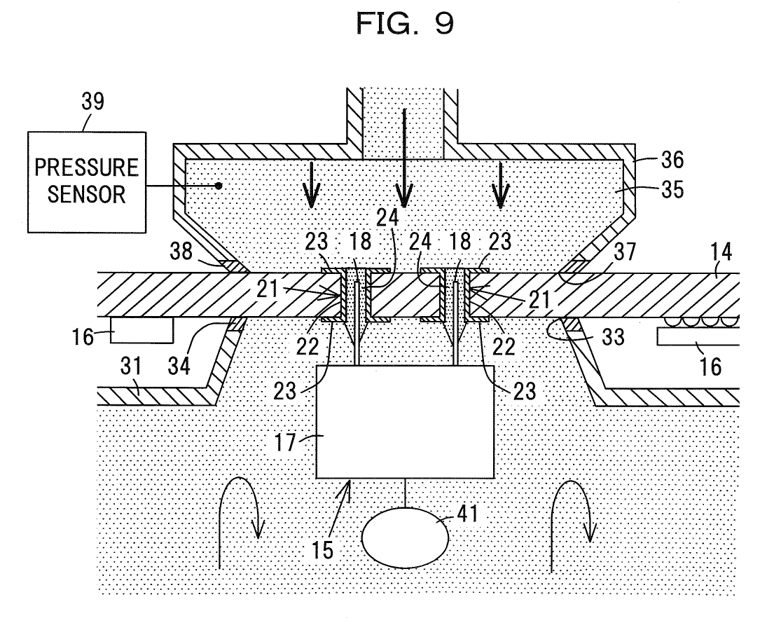

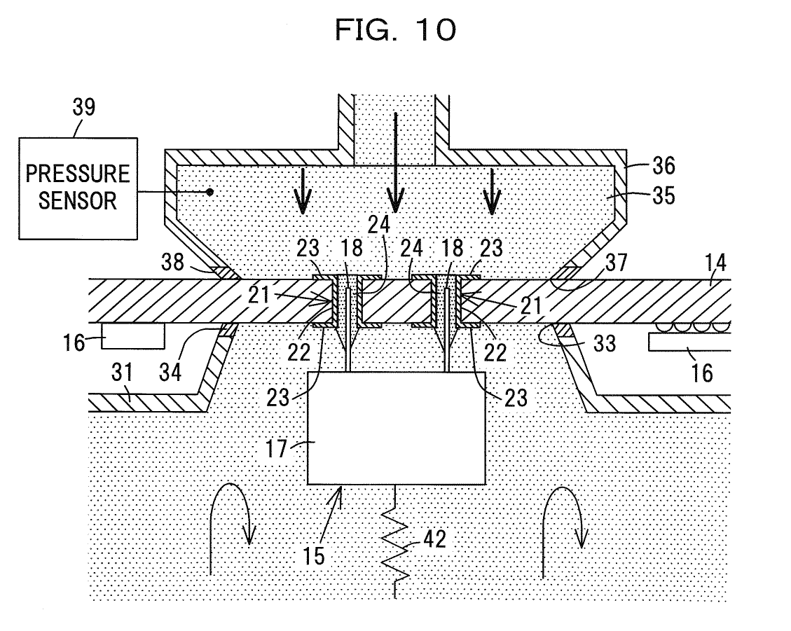

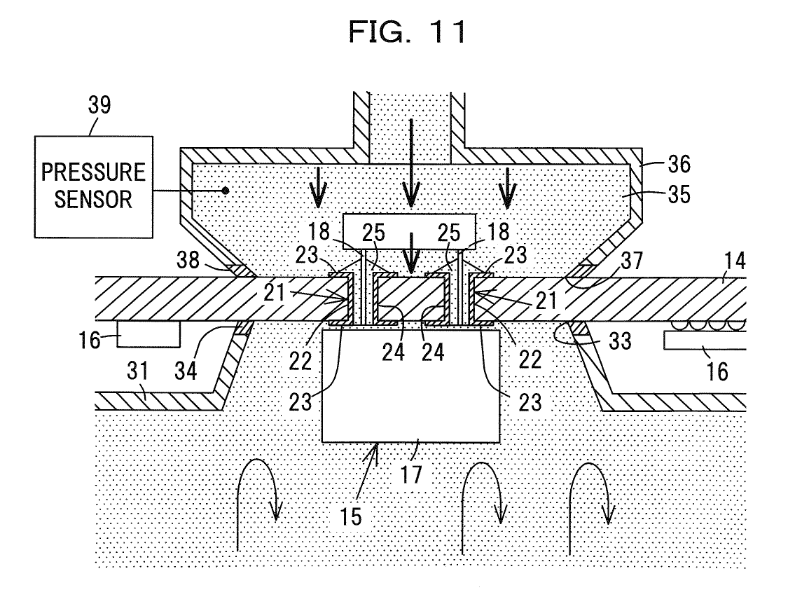

As shown in FIG. 9, in the above-described method for dismounting the electronic device 15, a weight 41 may be attached to the main electronic device body 17 in advance. The weight 41 exerts a dismounting force on the electronic device 15. Thus, the weight 41 facilitates dropping of the electronic device 15. Alternatively, as shown in FIG. 10, a pulling mechanism 42 may be attached to the main electronic device body 17 in advance. For example, a coil spring can be used as the pulling mechanism 42. The pulling mechanism 42 pulls the main electronic device body 17 in the vertical direction. In this way, the pulling mechanism 42 exerts a dismounting force on the electronic device 15 and facilitates dropping of the electronic device 15. Still alternatively, as shown in FIG. 11, a pushing mechanism 43 may be brought into contact with the top portion of the terminal pin 18 on the back surface of the printed board 14. The pushing mechanism 43 exerts a dismounting force on the electronic device 15. The pushing mechanism 43 urges the electronic device 15 towards the inside of heating bath 31 and facilitates dropping of the electronic device 15. Note that such a dismounting force may be used in the method for dismounting the electronic device 15 according to aspects of the first embodiment.

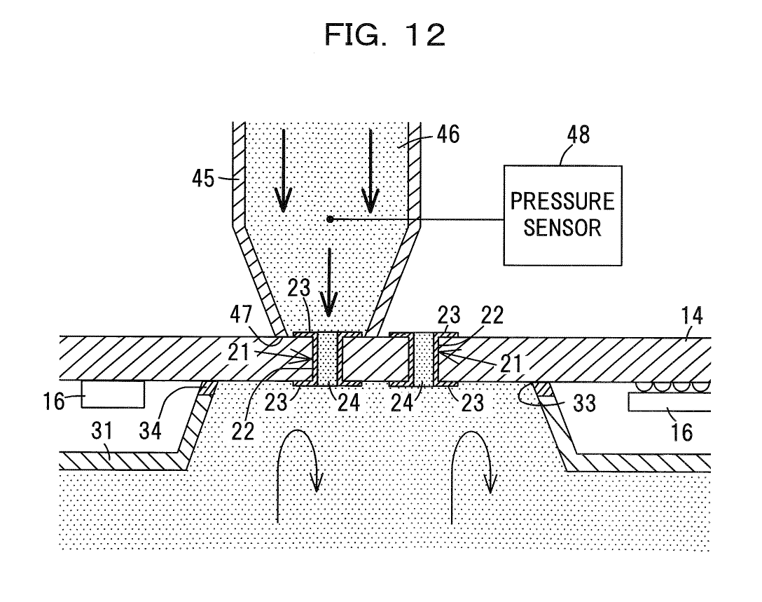

As shown in FIG. 12, in the above-described methods for dismounting the electronic device 15, a supply nozzle 45 may be provided on the back surface of the printed board 14 after the electronic device 15 is dismounted. High-temperature inert liquid 46 is disposed in the supply nozzle 45. Fluorinated liquid made of a material the same as that of the inert liquid 32 is used as the inert liquid 46. An opening 47 formed in the top portion of the supply nozzle 45 is in contact with the corresponding through-hole 21. The pressure of the inert liquid 46 in the supply nozzle 45 is set so as to be higher than the pressure of the inert liquid 32 in the heating bath 31. In order to set the pressure, a pressure sensor 48 is used. Note that the same numbering will be used in describing FIG. 12 as is utilized above, where appropriate.

The solder 24 in the through-hole 21 is heated by the inert liquid 32 in the heating bath 31 and the inert liquid 46 in the supply nozzle 45. When the solder 24 is melted in the through-hole 21, the inert liquid 46 flows from the supply nozzle 45 into the heating bath 31 via the through-hole 21 due to the difference in pressure. Such flow of the inert liquid 46 pushes the solder 24 remaining in the through-hole 21 to the inside of the heating bath 31. As a result, the solder 24 can be prevented from remaining in the through-hole 21.

Examples of embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

What is claimed is:

1. A method for dismounting an electronic device mounted on a printed board by solder, the electronic device having a terminal pin disposed in a through-hole of the printed board extending from a front surface to a back surface of the printed board, the terminal pin being joined to the printed board by the solder, the method comprising:
providing a heating bath having a heated inert liquid;
heating the electronic device by dipping the electronic device in the inert liquid heated in the heating bath; and
melting the solder in the through-hole using heat transferred from the electronic device.

2. The method for dismounting an electronic device according to claim 1, wherein when the electronic device is heated, a main body of the electronic device joined to the terminal pin is exposed to the inert liquid.

3. The method for dismounting an electronic device according to claim 2, wherein when the electronic device is heated, the front surface of the printed board is exposed to the inert liquid.

4. The method for dismounting an electronic device according to claim 1, further comprising supplying inert liquid in a supply nozzle from the back surface of the printed board to the through-hole when the electronic device is heated.

5. The method for dismounting an electronic device according to claim 4, wherein a pressure of the inert liquid in the supply nozzle is higher than a pressure of the inert liquid in the heating bath.

6. The method for dismounting an electronic device according to claim 1, further comprising exerting a dismounting force on the electronic device in a direction away from the front surface of the printed board, when the solder is melted.

7. The method for dismounting an electronic device according to claim 1, wherein the inert liquid is fluorinated liquid.
